(19) United States
(12) Patent Application Publication
(10) Pub. No.: US 2019/0108576 A1
(43) Pub. Date: Apr. 11, 2019

(54) BLOCKCHAIN SYSTEMS AND METHODS FOR PROCUREMENT

(71) Applicant: Capital One Services, LLC, McLean, VA (US)

(72) Inventors: Frank LaPrade, Washington, DC (US); Matthew Tomaszewicz, San Francisco, CA (US)

(73) Assignee: Capital One Services, LLC, McLean, VA (US)

(21) Appl. No.: 16/156,697

(22) Filed: Oct. 10, 2018

Related U.S. Application Data
(60) Provisional application No. 62/570,946, filed on Oct. 11, 2017.

(51) Int. Cl. G06Q 30/06

(52) U.S. Cl. CPC G06Q 30/0635

(57) ABSTRACT

Computer-implemented methods and systems are provided for a procurement system. Consistent with disclosed embodiments, the procurement system may include at least one processor and at least one non-transitory memory containing instructions that, when executed by the at least one processor, cause the procurement system to perform operations. The operations may include creating, in a blockchain, a contract corresponding to a procurement request including a first procurement parameter, the contract including contract code enforcing procurement obligations. The operations may include receiving, from at least one user system, at least one additional procurement request including at least one second procurement parameter and indicating the contract. The operations may also include generating a contract execution result by executing the contract code using the first procurement parameter and the at least one second procurement parameter; and updating the blockchain based on the contract execution result.

### RELATED APPLICATION

This application claims the benefit of priority of U.S. Provisional Patent Application No. 62/570,946, filed Oct. 11, 2017, the contents of which are incorporated herein by reference in their entirety.

### TECHNICAL FIELD

The disclosed embodiments concern systems and methods for using blockchain in the procurement process. More specifically, the disclosed embodiments concern embedding procurement information in a blockchain to enable automatic, transparent, immutable and irrevocable execution of procurement contracts.

### BACKGROUND

Managing enterprise procurement requires significant investment of time, money, and skilled personnel. Traditional enterprise procurement may be implemented over multiple databases and using disparate systems. These systems often require human oversight and inputting of contracts. This may impose significant burdens, for example making it difficult and time-intensive to manage and verify suppliers. Also, individual enterprises may lack sufficient leverage to obtain preferable pricing and may have difficulty locating suppliers for less-frequently required items. A need therefore exists for systems and methods for procurement that reduce the requirements for multiple databases and human oversight and intervention in the procurement process. The disclosed embodiments provide a specific implementation of such a procurement system.

### SUMMARY

The disclosed embodiments may comprise a procurement system including a user system, a management system, and a blockchain. The management system may intermediate between the user system and the blockchain. The management system may be configured to create and add contracts to the blockchain, and to ensure that the blockchain stores an immutable, irrevocable record of performance of procurement obligations.

The disclosed embodiments may include, for example, a procurement system comprising at least one processor and at least one non-transitory memory containing instructions. When executed by the at least one processor, the instructions may cause the procurement system to perform operations. The operations may comprise creating, in a blockchain, a contract corresponding to a procurement request. The procurement request may include a first procurement parameter. The contract may include contract code enforcing procurement obligations. The operations may include receiving, from at least one user system, at least one additional procurement request. The additional procurement request may include at least one second procurement parameter and may indicate the contract. The operations may include generating a contract execution result by executing the contract code using the first procurement parameter and the at least one second procurement parameter. The operations may further include updating the blockchain based on the contract execution result.

The disclosed embodiments may include, for example, a management system comprising at least one processor and at least one non-transitory memory containing instructions. When executed by the at least one processor, the instructions may cause the management system to perform operations. The operations may comprise storing procurement requests received from at least one user system in at least one database. The operations may further comprise creating contracts in a blockchain. The contract created in the blockchain may correspond to the procurement requests and may comprise contract code enforcing procurement obligations. The operations may comprise providing input data concerning procurement obligations to the contracts. The operations may comprise receiving contract execution results generated by executing the contract code using the input data and may also comprise outputting the contract execution results.

The disclosed embodiments may include, for example, a procurement method comprising steps. The steps may include creating contracts for group buying arrangements in a blockchain. The contacts for group buying arrangements may include contract code enforcing procurement obligations. The steps may also include receiving, from user systems, procurement requests to enter into the contracts. The steps may further include prompting the contracts with input data concerning the procurement obligations. The steps may additionally include receiving, in response to the prompting, contract execution results generated by executing the contract code using the input data, and may also include providing the contract execution results to the user systems.

In some aspects, the contract execution results may include software keys. Additionally or alternatively, creating contracts for group buying arrangements may include storing rules implementing the group buying arrangements in a database, receiving information concerning procurement obligations, and applying the stored rules to the information to generate the input data.

It is to be understood that both the foregoing general description and the following detailed description are exemplary and explanatory only and are not restrictive of the disclosed embodiments, as claimed.

### BRIEF DESCRIPTION OF THE DRAWINGS

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure. In the drawings:

FIG. 1 depicts a schematic of an exemplary procurement system.

FIG. 2 depicts a logical model of an exemplary contract in communication with external resources.

FIG. 3 depicts an exemplary procurement process.

FIG. 4 depicts a schematic of an exemplary procurement system.

FIG. 5 depicts a schematic of an exemplary computing device for performing the envisioned systems and methods.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

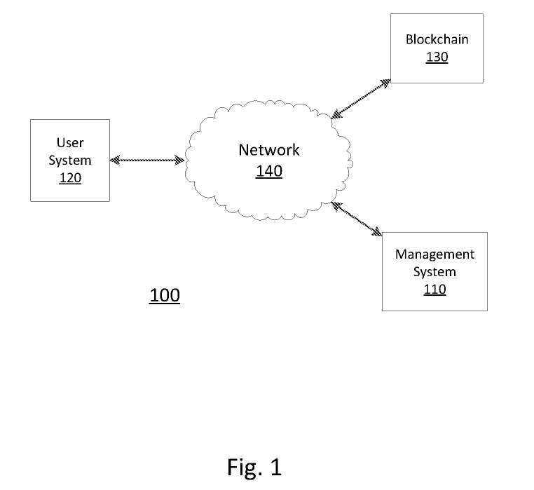

FIG. 1 depicts an exemplary procurement system (system 100), consistent with disclosed embodiments. In some embodiments, system 100 may comprise management system 110, user system 120, and blockchain 130. The elements of system 100 may be configured to communicate with each other, or with other systems, using network 140. In some embodiments, system 100 may be configured to enable user system 120 (and management system 110) to enter into procurement arrangements using contracts stored in blockchain 130. As would be recognized by one of skill in the art, the description of system 100 in FIG. 1 is not intended to be limiting. In some embodiments, additional elements may be added, and/or the depicted elements of system 100 may be combined, divided, modified, or removed. For example, envisioned embodiments may implement a superset or a subset of the depicted elements of system 100. As an additional example, in some embodiments, blockchain 130 may be implemented with, or combined into another element of system 100 (e.g., management system 110). In such embodiments, blockchain 130 may be stored in by a non-transitory computer memory operated by the other element of system 100.

The procurement arrangements may be dynamic, consistent with disclosed embodiments. For example, obligations under the procurement arrangement may be subject to modification before or during performance of the procurement arrangement. Such modification may be automatic, accomplished through the application of rules or formulas to the terms and conditions (collectively referred to as obligations) of the dynamic procurement arrangement. In some instances, the procurement obligations may not be fixed until some criteria is satisfied. For example, the parties to a procurement arrangement, or the total quantities, or the prices per unit, or the delivery date, or other terms that would be familiar to one of ordinary skill in the art may be subject to modification until some criteria is satisfied. Additionally or alternatively, the procurement obligations may be mutually dependent. For example, the modification of a first performance obligation may affect another performance obligation. Such a dependence may be determined by rules or formulae. For example, the price per unit may depend upon the unit quantity ordered according to a predetermined formula. Similarly, each procuring party may be obligated to purchase at least a minimum amount, and the addition of more procuring parties may increase the total amount purchased. As would be recognized by one of skill in the art, these rules may interact with each other. For example, adding procuring parties subject to minimum quantity requirements may cause the price per unit to decrease.

In this manner, dynamic procurement arrangements may include group buying arrangements, conditional purchasing arrangements, and similar arrangements. System 100 addresses problems of trust, verifiability, and collective action through a specific way of implementing these dynamic procurement arrangements using contracts in a blockchain. In some aspects, the contract is self-executing within terms of agreement between the parties to the contract. Such self-executing contracts may also be called “smart contracts.” The code, agreements, and terms of the contract may be dynamically updated and are stored across a distributed, decentralized ledger or network like a blockchain. In an Ethereum implementation, contracts may be written in a language, such as Solidity, Serpent, or other similar language, and then may be compiled into bytecode to be uploaded on the blockchain. As described in greater detail below, these contracts include contract code enforcing procurement obligations.

System 100 may be configured to prompt these contracts with input data, causing the contract code to execute, generating a result. Depending on the contract, this contract execution result may comprise at least one of an exchange of information, a transfer of an asset, and creation of a record indicating execution of the contract. The contract execution results may be provided at least in part to at least one of the parties to the procurement arrangement. In some aspects, recording the contracts in the blockchain may create an immutable, irreversible, and verifiable record of procurement obligations.

Additionally, users may effectuate escrow arrangements by joining contracts. For example, a contract may be configured with contract code that requires transfer of an asset as a condition on further execution of the contract code. For example, the code may require confirmation that the asset has been placed in an escrow account as a condition on further execution of the code. The asset may include currency, such as US dollars, or cryptocurrency, such as Bitcoins or Ether, or rights, such as software keys or other cryptographic keys. The contract may be configured to transfer these assets to the appropriate party when generating the contract execution result.

Management system 110 may include one or more computing devices, such as servers, workstations, desktop computers, or special-purpose computing devices, consistent with disclosed embodiments. Management system 110 may be standalone, or it may be part of a subsystem, which may be part of a larger system. In some aspects, management system 110 may comprise multiple distinct management systems associated with distinct entities. As a non-limiting example, management system 110 may comprise management systems associated with multiple different entities. As a non-limiting example, management system 110 may comprise management systems associated with two or more financial institutions. These management systems may be able to operate on blockchain 130 independently, for example by independently receiving requests and updating blockchain 130. These management systems may be able to operate on blockchain 130 collectively, for example by cooperatively updating a shared representation of blockchain 130 using the requests received by all management systems.

For example, management system 110 may be associated with one or more commercial institutions. Management system 110 may include distributed servers that are remotely located and communicate with other systems of the one or more commercial institutions over a public network, or over a dedicated private network. In some aspects, management system 110 may be implemented using an on-demand computing platform. For example, management system 110 may be implemented using a cloud computing service.

Management system 110 may be configured to intermediate between user system 120 and blockchain 130, consistent with disclosed embodiments. Management system 110 may be configured to expose an application layer to user system 120. This application layer may enable user system 120 to retrieve information about blockchain 130 and provide requests to modify the status of blockchain 130. Such requests may concern creating one or more contracts in blockchain 130, modifying one or more accounts associated with user system 120, joining one or more existing contracts in blockchain 130, and/or canceling or withdrawing from one or more existing contracts on blockchain 130. The application layer may be configured to provide file management functionality for users of system 100. For example, the application layer may be configured to enable users to upload, review, organize, associate or label with metadata, and/or delete information related to requests.

The application layer may also be configured to handle authentication and authorization of user system 120, consistent with disclosed embodiments. For example, the application interface may be configured to require a username and password to access at least some of the functionality offered by system 100. The application layer may be configured to provide differing functionality to different users. For example, certain users may be authorized to use the application interface to read and write information to blockchain 130, while other users may only be authorized to read information from blockchain 130. As would be appreciated by one skill in the art, these examples are not intended to be limiting.

Management system 110 may be configured to maintain one or more databases storing information associated with requests from user system 120, consistent with disclosed embodiments. In some aspects, management system 110 may be configured to host the one or more databases. In some aspects, the one or more databases may be hosted on another system and management system 110 may be configured to access this other system to maintain the one or more databases. The one or more databases may include, for example, a database storing requests for future commitment to blockchain 130. Management system 110 may be configured to buffer requests received from user system 120 using this database. For example, management system 110 may be configured to write requests to this database as they are received from user system 120. Management system 110 may be configured to retrieve sets of requests stored in this database and use the retrieved sets of requests to generate a new block for incorporation in blockchain 130. Additionally or alternatively, the one or more databases may include, for example, a database storing at least one of data and rules. The stored data and rules may be generated from requests received by management system 110 from user system 120. In some embodiments, management system 110 may be configured to use this database to reduce the computational complexity of the contracts stored on the blockchain and/or to limit the disclosure of information concerning procurement obligations. Additionally or alternatively, the one or more databases may include, for example, a database storing documents corresponding to the procurement requests. For example, this database may include copies of purchase orders, acceptances, bills of sale, requests for proposals, or similar documents specifying procurement obligations. These documents may provide legal records corresponding to the records stored in blockchain 130.

In some embodiments, one or more of the databases may be a distributed database. For example, when management system 110 comprises multiple systems associated with differing entities, the databases may comprise one or more distributed databases. One or more of these databases may incorporate blockchain elements, as disclosed in “BigchainDB: A Scalable Blockchain Database” by McConaghy et al., which is incorporated herein by reference. One or more of these databases may implement a peer-to-peer distributed file system, as disclosed in “IPFS—Content Addressed, Versioned, P2P File System (DRAFT 3)” by Benet, also incorporated herein by reference. One of ordinary skill in the art would recognize that the disclosed databases are not limited to the above exemplary implementations.

In some embodiments, management system 110 may be configured to execute a virtual machine. This virtual machine may be configured to generate new blocks in blockchain 130 based on the received procurement requests. Management system 110 may be configured to implement software agents that interact with this virtual machine. In some embodiments, the software agents may respond to requests from contracts in the blockchain. For example, a contract may be configured to request information from an external resource during execution of contract code for that contract. This request may be handled by a software agent of management system 110.

In some embodiments, the software agents may call functions of contracts in blockchain 130 (i.e., invoke a contract). In some aspects, the software agents may be configured to invoke the contracts when criteria are satisfied. The criteria may include a time condition. This time condition may concern a due date, an elapsed time, or some other time condition known in the art. The criteria may include a data condition. This data condition may concern a request or value received from user system 120. For example, a software agent may be configured to retrieve price data from another system and invoke a contract when this price data satisfies a price criterium. As another example, a software agent may be configured to poll a web service for a temperature value in a particular city, and to invoke a contract when the temperature satisfies a temperature criterium. As an additional example, a software agent may invoke a contract when a number of requests concerning a contract have been received, such as when a predetermined number of buyers have requested to join a group buying contract. As a further example, a software agent may be configured to invoke one or more contracts when a procurement obligation has been satisfied or breached. For example, a software agent may be configured to determine, based on the information stored in the one or more databases of the management, that a procurement obligation for a contract has been satisfied. The software agent may be configured to invoke the contract and may be configured to provide to the contract an indication that the obligation has been satisfied. As a non-limiting example, given a request to join a contract stored in the at least one database, a software agent may be configured to determine that the request includes a quantity value satisfying corresponding criteria for a contract on blockchain 130.

User system 120 may include one or more computing devices, such as servers, workstations, desktop computers, or special-purpose computing devices, consistent with disclosed embodiments. User system 120 may be standalone, or it may be part of a subsystem, which may be part of a larger system. In some aspects, user system 120 may comprise multiple distinct user systems associated with distinct entities. As a non-limiting example, user system 120 may comprise distinct user systems associated with multiple different entities acting as purchasers and/or suppliers. User system 120 may include distributed servers that are remotely located and communicate with other systems of the multiple different entities over a public network, or over a dedicated private network. In some aspects, user system 120 may be implemented using, or may be include user systems implemented using, an on-demand computing platform. For example, user system 120 may comprise multiple user systems including a user system for a commercial institution implemented using a cloud computing service.

User system 120 may be configured to provide procurement requests to management system 110. As described above, user system 120 may be configured to provide the requests using the application layer of management system 110. The requests may concern creating one or more contracts in blockchain 130, modifying one or more accounts associated with user system 120, joining one or more existing contracts in blockchain 130, and/or canceling or withdrawing from one or more existing contracts on blockchain 130. As would be recognized by one of skill in the art, these exemplary requests are not intended to be limiting.

Blockchain 130 may comprise a sequence of blocks, consistent with disclosed embodiments. Each block may depend on one or more previous blocks in the sequence, such that modifying or replacing a block may require an infeasible re-computation of all subsequent blocks. In this manner, blocks in the blockchain may be preserved from tampering, creating an immutable and irrevocable record. For example, each block may describe a current state. This state may include a state for each contract. This state may include function descriptions for the contract, a number of times contract functions had been invoked, contract data, and/or contract code. As described above, management system 110 may be configured to generate new blocks in blockchain 130 by executing contract code using a virtual machine. The new block reflects the resulting contract execution results, creating an immutable and irrevocable record of the contract execution. In some embodiments, blockchain 130 may rely on a “proof-of-work” scheme, a “proof-of-stake” scheme, or some hybridization of “proof-of-work” and “proof-of-stake” to validate new blocks, as known by one of skill in the art. The difficulty of the proof may depend on the degree of access afforded to blockchain 130. When management system 110 is associated with a single entity, a minimally difficult proof, or no proof at all, may be required to validate a new block. In such a scenario, new blocks may simply be added to blockchain 130. When management system 110 comprises multiple management systems associated with multiple entities, each with the ability to add blocks to blockchain 130, a greater degree of proof may be required to validate a new block.

Blockchain 130 may comprise multiple blockchains maintained by many different systems (e.g., management system 130 or other systems). In some aspects, blockchain 130 may be implemented as a distributed database. For example, management system 120 may comprise multiple distinct management systems, each maintaining a version of blockchain 130. In some aspects, these multiple distinct management systems may each control the writing of blocks to their version of blockchain 130. As would be appreciated by one of skill in the art, these versions may differ, and system 100 may be configured to reconcile these differences.

Network 140 may be configured to provide communications between components of FIG. 1. For example, network 140 may be any type of network (including infrastructure) that provides communications, exchanges information, and/or facilitates the exchange of information, such as the Internet, a Local Area Network, or other suitable connection(s) that enables system 100 to send and receive information between the components of system 100.

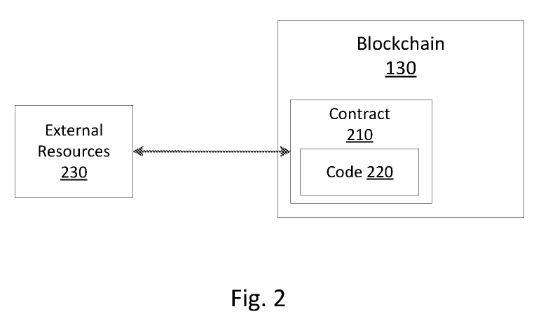

FIG. 2 depicts a depicts a logical model of an exemplary contract 210 in communication with external resources 230, consistent with disclosed embodiments. In some embodiments, blockchain 130 may be configured to store contract 210. In turn, contract 210 may comprise contract code the enforces procurement obligations associated with contract 210. Contract 210 may be configured to interact with external resources 230. For example, as described in detail below, contract 210 may be invoked by one or more of external resources 230, or may be configured to request input data from one or more of external resources 230. As would be recognized by one of skill in the art, the logical model described in FIG. 2 is not intended to be limiting. In some embodiments, additional elements may be added, and/or the depicted elements may be combined, divided, modified, or removed. For example, contract 210 may comprise a collection of contracts. When properly invoked, these contracts may interoperate to enforce performance obligations. For example, a forwarding contract may be configured to only invoke another contract when appropriate conditions are met. The forwarding contract may take an address of the other contract as a parameter. Such a forwarding contract may implement procurement logic for an entity associated with a user, requiring authorizing signatures from appropriate users before another contract for a requested good or service may be invoked. Thus contract code 220 may be realized by contract code associated with a collection of contracts. Furthermore, the envisioned embodiments may implement a superset or a subset of elements depicted in FIG. 2.

As described above, contracts (e.g., contract 210) may be embedded in block, and each block reflecting a current value of a state. In some embodiments, the contract may indicate a counterparty obligated to fulfil the procurement request. This indication may include a name or identifier of the counterparty. For example, when a major retailer is the counterparty, the name of the major retailer may be specified in the contract. As an additional example, a number associated with the major retailer may be specified in the contract. The indication may include account information of the counterparty, which may correspond to a cryptographic currency account, such as an account on blockchain 130, or a traditional financial account. The indication may be encrypted, for example using a private key or symmetric key associated with management system 110 and/or with the counterparty. In various aspects, the contract may similarly indicate the parties to the contract.

Contracts may comprise executable code (e.g., code 220), which may be invoked using function definitions defined in the contract. In some aspects, this code may be bytecode. Contracts may receive input data when invoked and may request input data from external resources (e.g., external resources 230). In some embodiments, external resources may provide data concerning performance of contract obligations. For example, the external resources may provide shipping information, such as tracking numbers or receipt confirmations. In some aspects, the external resources may provide the result of applying rules to information concerning performance requests, such as indications of whether sufficient total quantities have been ordered to satisfy a quantity condition in a contract. One of ordinary skill in the art would appreciate that simple rules may be combined to enforce complicated policies on performance requests. Such complicated policies may exceed the storage capabilities allotted to contracts on blockchain 130, or the processing and communication capabilities of the virtual machine. By offloading determination of compliance with these policies to external resources 230, system 100 may implement sophisticated procurement policies while still taking advantage of the immutability and irrevocability of blockchain 130. In some embodiments, external resources 230 may be configured to invoke contract 210. For example, external resources 230 may determine that one or more criteria associated with a contract has been satisfied. The external resources 230 may then invoke the contract, for example using a software agent as described above with respect to management system 110.

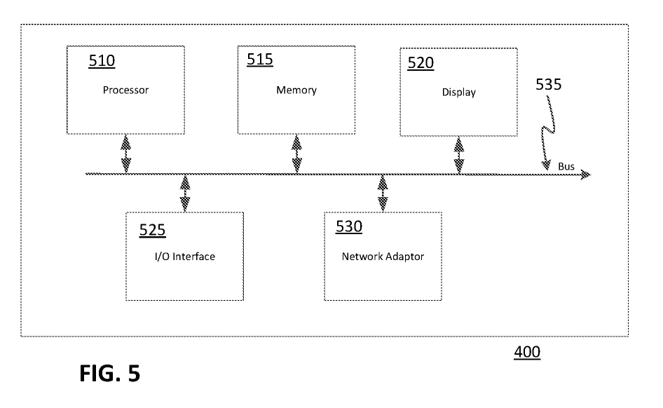

External resources 230 may be part of management system 110, another component of system 100 (e.g., user system 120), and/or part of another system. In some aspects, external resources 230 may be an oracle as described below in more detail with respect to FIG. 5. In some embodiments, external resources used by a contract may be specified in the contract. For example, contract code 220 may specify a particular external resource as a provider of input data. As an additional example, contract code may determine the identity of a particular external resource during execution of the contract code. This determination may depend on previously received input data and may depend on other parameters such as the virtual machine context during execution of the contract code. In various embodiments, contracts may be invoked with references to relevant external resources.

An invoked contract may output a contract execution result, consistent with disclosed embodiments. The contract execution result may comprise at least one of data and instructions. In some embodiments, the contract execution result may indicate whether the procurement contract was successfully executed. For example, when the procurement contract includes contract code enforcing a procurement obligation (e.g., a condition on the type of good, price, quantity, payment terms, delivery terms, or other procurement parameter known to one of skill in the art), the contract execution result may indicate whether a procurement request satisfies the procurement obligation. As a further example, when multiple procurement requests join a contract on blockchain 130, the contract execution result may indicate whether each procurement request satisfies the procurement obligation. The contract execution result may indicate whether the procurement requests jointly satisfy the procurement obligation. For example, when a group buying contract includes a total quantity obligation, the contract execution result may indicate that multiple procurement requests jointly satisfied this total quantity obligation. In various embodiments, the contract execution result may comprise cryptographic keys. In some aspects, the contract execution results may include software keys enabling the use of software programs. For example, a user may download a software program. This software program may offer limited functionality without entry of a software key. A seller of the software program may have interacted with system 100 to create a contract on blockchain 130 for this software. The user may interact with system 100 to provide a procurement request to join this contract. This request may cause system 100 to invoke the contract. The contract execution result may comprise one or more software keys removing restrictions on the functionality of the software. In some aspects, the provided software keys may be encrypted, for example using a symmetric or public key associated with the user and/or with system 100. This may enable transfer of the keys to the user without concerns about public disclose of the software keys.

As described above, contract invocation and request handling may be performed by software agents of management system 110. Exemplary systems and methods for structuring and managing blockchain 130, consistent with disclosed embodiments, are described in “Ethereum: a Secure Decentralised Generalised Transaction Ledger Homestead Revision,” by Dr. Gavin Wood (the “Ethereum Yellow Paper”), incorporated herein by reference in its entirety. One of skill in the art would recognize that alternative implementations are possible, and the implementation described in the Ethereum Yellow Paper is not intended to be limiting.

As a non-limiting example, contract 210 may be a group buying contract. Contract 210 may include contract code 220 enforcing procurement obligations for this group buying contract. For example, contract code 220 may be configured to indicate a supplier, a minimum quantity per purchaser, and a unit price dependent on the total quantity ordered. Management system 110 may receive procurement requests from multiple user systems corresponding to different entities to join this contract. In some embodiments, the procurement requests may identify the entities and the desired purchasing quantities.

Management system 110 may be configured to process these performance requests, consistent with disclosed embodiments. In some aspects, management system 110 may generate input data from these requests. For example, management system 110 may be configured to provide an interface, such as a graphical user interface, enabling users to enter information regarding performance obligations. Users may interact with the interface to upload documents and/or provide procurement parameters. Management system 110 may be configured to extract the desired purchasing quantities from the documents according to known methods. In various aspects, management system 110 may be configured to determine conformance of procurement requests with performance obligations of an existing contract. In this non-limiting example, management system 110 may be configured to validate the desired purchasing quantities against the minimum quantities for each requesting entity.

Management system 110 may be configured to execute a virtual machine, invoking contract 210 and providing to contract 210 the input data concerning the procurement requests. For example, management system 120 may be configured to execute contract code 210 using the input data to generate a contract execution result. In this non-limiting example, the contract execution result may indicate the entities desiring to purchase at least the minimum quantity, and the price per unit. This information may be stored in a non-transitory memory. In some aspects, the contract execution result may be stored on blockchain 130. For example, contract 220 may comprise memory for storing a contract state. This contract state may reflect the contract execution result. As an additional example, at least one of the entities may have an account stored on blockchain 130. Execution of contract code 210 may affect the state of this account. Management system 110 may be configured to generate a block reflecting the state of system 100 following execution of contract code 210. This block may depend on the current state of the system, including the contract execution result, and the prior block in blockchain 130.

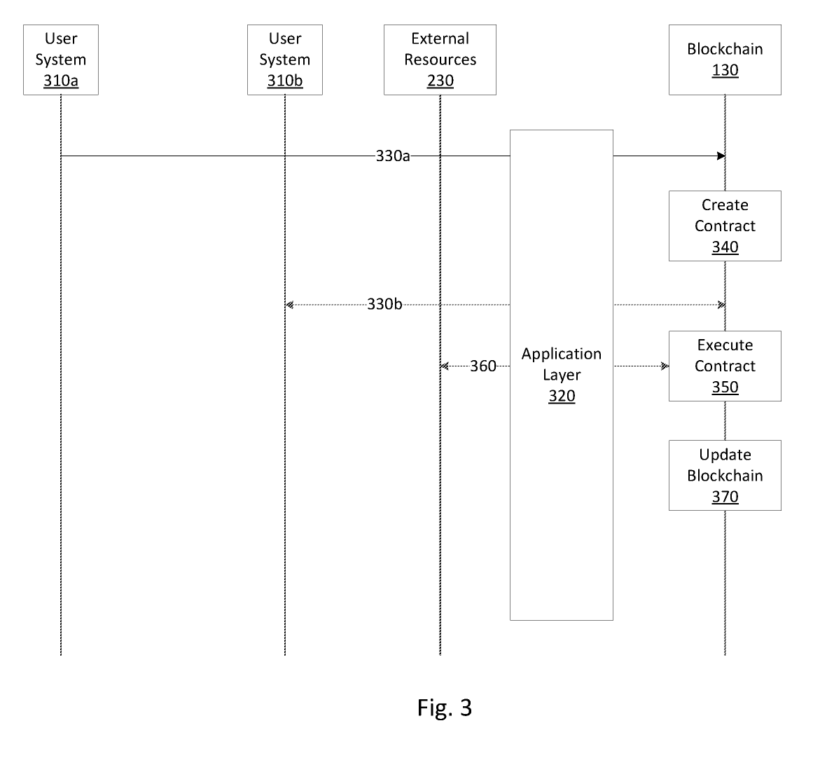

FIG. 3 depicts an exemplary procurement process consistent with disclosed embodiments. In some embodiments, blockchain 130 may be configured to interact with user systems (e.g., user system 310a and user system 310b) and external resources 230 to generate an immutable, irrevocable record of procurement requests. Blockchain 130 may be configured to interact with one or more of the user systems and external resources 230 using application layer 320. Application layer 320 may be implemented by management system 110. Software agents, as described above with respect to FIG. 1, may be configured to handle communications between application layer 320 and blockchain 130. In some aspects, one or more of user system 310a and user system 310b may comprise a supplier of a good or service. Likewise, in some aspects, one or more of user systems 310a and 310b may comprise a purchaser of a good or service. As would be recognized by one of skill in the art, the process depicted in FIG. 3 is not intended to be limiting. In some embodiments, additional steps may be added, and/or the depicted steps of FIG. 3 may be combined, divided, modified, or removed. For example, envisioned embodiments may implement a superset or a subset of the depicted steps of FIG. 3.

User system 310a may be configured to interact with application interface 320 in step 330a, consistent with disclosed embodiments. In some aspects, as described above, application layer 320 may be provided by management system 110. User system 310a may be configured to interact with application layer 320 to provide a procurement request. Providing a procurement request may include uploading documents using application interface 320. As a non-limiting example, these documents may include purchase orders, contracts, requests for proposals, or similar procurement-related documents. Providing a procurement request may also include interacting with a graphical user interface provided by application layer 320. The graphical user interface may enable a user to enter procurement parameters, such as type of good or service, quantity, payment terms, and delivery terms. As described above with respect to FIG. 1, application layer 320 may be configured to maintain one or more databases. In some aspects, one of the one or more databases may be configured to store any uploaded documents. In various aspects, one of the one or more databases may be configured to buffer procurement requests for processing in a single block. In some aspects, one of the one or more databases may be configured to store rules implementing the performance obligations. In some embodiments, application layer 320 may be configured to provide a request to create a contract in blockchain 130, based on the received procurement request.

In step 340, blockchain 130 may be configured to create a contract, consistent with disclosed embodiments. In some aspects, the contract is a “smart contract,” as described above. The code, agreements, and terms of the contract may be dynamically updated and are stored across a distributed, decentralized network like blockchain 130.

In some aspects, creation of a contract may involve updating the blockchain. For example, management system 110 may be configured to update the blockchain to include the contract using the virtual machine. A new block may be added to the blockchain, the new block including the contract. The contract may be created with contract code enforcing the procurement obligations specified in the procurement request. The contract code may be created by management system 110. The creation request may be configured to include the contract code. For example, application layer 320 may be configured to dynamically and automatically “write” business terms and rulesets into code that are executed when prompted by data sources. This may allow technical contracts to be executed without human oversight.

In step 330b, user system 310b may be configured to invoke the contract, consistent with disclosed embodiments. In some aspects, before or after invoking the contract, user system 310b may be configured to query application layer 320 for an indication of available contracts on blockchain 130. This query may result from interactions between a user and user system 310b. Application layer 320 may be configured to provide the indication based on the state reflected in the most recent block in blockchain 130. In some aspects, the indication may include a display of available contracts. The display may include at least some procurement parameters of the available contracts. For example, the display may include a selectable list of available contracts. User system 310b may be configured to interact with application layer 320 to select at least one of the available contracts. In response, application layer 320 may be configured to provide additional information regarding the selected at least one of the available contracts. In some aspects, the information displayed in the indication may be restricted. For example, in some embodiments at least a portion of the information stored on blockchain 130 may not be publically accessible. Application may be configured to determine an authorization level of the requesting user, or of user system 310b. The information provided in response to the request from user system 310b may depend on the authorization level and the degree of access to the information granted by application layer 320. In some aspects, only a subset of procurement parameters may be displayed for each contract. For example, for a lower authorization level, types of goods and services for existing contracts may be displayed, together with identifiers for the suppliers and/or purchasers for the contracts. But payment and delivery terms may not be displayed without a higher authorization level. In some embodiments, management system 110 may be able to interact with application layer 320 to view all procurement parameters and procurement obligations for all contracts in blockchain 130. In some aspects, user system 310b may be configured to interact with application layer 320 to provide a procurement request. Application layer 320 may be configured to process this procurement request in similar manner to the request from user system 310a, described above. Application layer 320 may be configured to invoke contracts on blockchain 130 based on the procurement request received from user system 310b. The invoked contracts may include the contract created in response to the procurement request from user system 310a.

In step 350, management system 310 may be configured to execute the contract. In some aspects management system 310 may be configured to execute the contract using a virtual machine. The virtual machine may be configured to execute the contract code to product a contract result. In some aspects, the virtual machine may be configured to execute the contract code using input data received from application layer 320 in the invocation request. In various aspects the virtual machine may be configured to execute the contract code using input data previously stored in blockchain 130. For example, the virtual machine may be configured to execute the contract code using input data received from application layer 320 in the request to create the contract. In some aspects, the virtual machine may be configured to invoke other contracts stored on blockchain 130 during execution of the contract code. For example, application layer 320 may be configured to provide a request to invoke a first contract, which in turn may invoke a second contract during execution.

In step 360, the virtual machine may be configured to request data from external resources 230, consistent with disclosed embodiments. For example, in some embodiments, as described above, application layer 320 may be configured to store rules implementing the procurement obligations in a database. Application layer 320 may be configured to receive procurement request and apply information from the procurement requests to the stored rules. For example, application layer 320 may be configured to generate rules implementing the procurement request received in step 330a and store these rules in a database. Application layer 320 may be configured to apply information from the procurement request received in step 330b to the stored rules to generate input data. In some aspects, this input data may be provided with the request to invoke the contract. In various aspects, the virtual machine may be configured to request this input data from external resource 230. In this manner, system 100 may be configured to maintain the immutability and irrevocability of the procurement obligations without burdening the blockchain with complicated rules. Such a use of external resources 230 may also allow for enforcement of arbitrarily sophisticated procurement obligations using a simple virtual machine. Furthermore, this use of external resources 230 may enable a division between information visible on the blockchain and information held in confidence by management system 110. In some embodiments, an external resource may be configured to provide input data independently of the procurement request in step 330b. For example, the external resource may provide input data concerning a procurement parameter relevant to the contract execution result, such as a third-party cost associated with a procurement obligation. For example, a procurement obligation may concern delivery terms, and the external resource may be configured to provide shipping costs retrieved from a shipping provider. For example, the virtual machine may be configured by the contract code to provide quantity information and delivery terms to the external resource, and the external resource may be configured to respond with shipping costs. The virtual machine may be configured by the contract code to use these shipping costs in determining the contract execution result. In some embodiments, an external resource may be configured to invoke the execution of the contract. For example, in some embodiments, the virtual machine may not be configured to execute the contract in response to the procurement request in step 330b, or may be configured to execute another function of the contract in response to this request. The virtual machine may then be configured to execute the contract, or another function of the contract, in response to a request received from one of the external resources 230.

In step 370, the virtual machine may be configured to update blockchain 130. In some embodiments, the update may reflect a changed status of the contract. In some aspects, the procurement request may add additional parties to the contract. For example, the procurement request in step 330b may comprise a request by the entity associated with user system 310b to join a contract, such as a group buying arrangement, between a supplier and the entity associated with user system 310a. In addition to adding new parties, the procurement request in step 330b may results in changes to existing procurement obligations. For example, the procurement request in step 330b may change quantities, payment terms (e.g., prices), and delivery terms.

In some embodiments, application layer 320 may be configured to output the contract execution result, or an indication of the contract execution result, to user system 310a and user system 310b. For example, application layer 320 may be configured to provide an indication that a function of the contract was invoked, the result of the invocation, the parties involved, or similar information concerning the contract execution. In some embodiments, application layer 320 may be configured to generate or update a document memorializing the invocation of the contract. Application layer 320 may be configured to store this new or updated document in the at least one database discussed above with reference to FIG. 1.

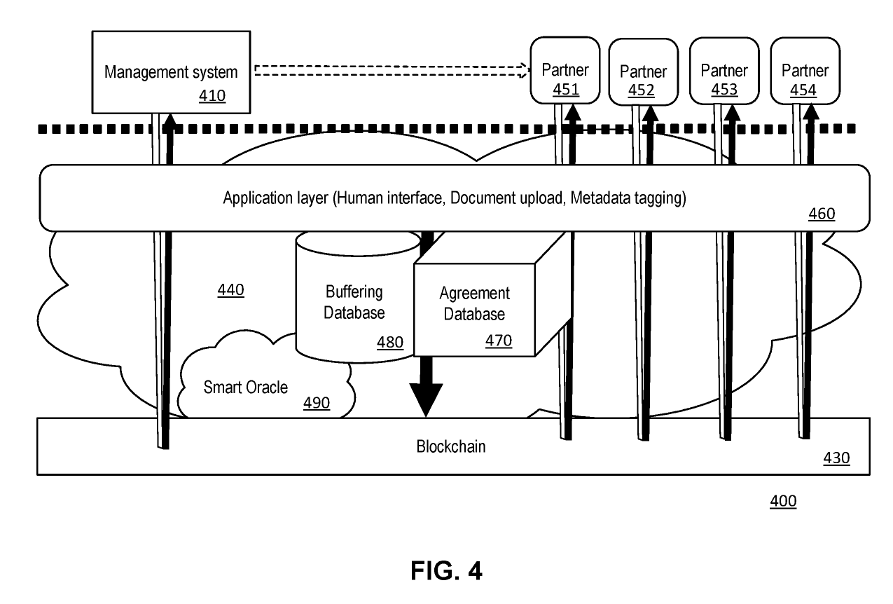

FIG. 4 depicts an exemplary procurement system (system 400), consistent with disclosed embodiments. In some embodiments, system 400 may comprise one or more management systems 410 and blockchain 430. Management systems 410 may be the same or similar to management systems 110 described above with respect to FIG. 1. Blockchain 430 may be the same or similar to blockchain 130 also described above. One or more management systems may belong to business partners (e.g. partner systems 451, 452, 453, and 454). System 400 may also comprise one or more user systems 420 (not shown). The elements of system 400 may be configured to communicate with each other, or with other systems, using network 440. In some embodiments, system 400 may be configured to enable management system 410 (and partner systems 451, 452, 453, and 454) to enter into procurement arrangements using contracts stored in blockchain 130.

In some embodiments, management system 410 may join with one or more of partner systems 451, 452, 453, and 454 to join a procurement contract. For example, a large commercial institution may have a contract with a supplier to purchase office equipment. System 400 may enable small business clients of the large commercial institution to join in the contract, even though the small business clients may each only intend to buy a limited quantity of office equipment. Once a predetermined quantity of office equipment has been ordered, system 400 will automatically execute the contract. The price per unit of the office equipment may depend on the quantity ordered. For example, the more office equipment ordered, the lower the unit price. The price per unit may differ between the purchasers. For example, the price per unit for the large commercial institution may be lower than the price per unit for the other users of the system 400.

In another example, a large commercial institution may have a contract with a supplier to purchase software licenses. Upon invocation of the contract, the license information for the software may be published to the blockchain. The license information may be encrypted using a public key or symmetrical key associated with the large commercial institution. The large commercial instruction may be able to decrypt this encrypted license information and use this information to personalize software downloaded through another channel. The blockchain may provide an irrevocable, immutable record of this license transfer.

Application layer 460 may be configured to intermediate between management system 410 (and/or one or more of partners 451, 452, 453, and 454), and blockchain 430, consistent with disclosed embodiments. Application layer 460 may enable these systems to retrieve information from blockchain 430 and provide requests to modify blockchain 430. In some aspects, management system 410 would receive requests from partners 451, 452, 453, and 454, and issue contracts which it would record with the blockchain. In other aspects, management system 410 would receive requests, aggregate the information, and create one or more multi-party contracts, that would then be transferred to blockchain 430. Application layer 460 may also be configured to handle authentication and authorization of management systems 410 and partner systems 451, 452, 453, and 454, consistent with disclosed embodiments. Application layer 460 may be configured to provide differing functionality to different systems. For example, certain systems may be authorized to read and write information to blockchain 430, while other systems may only be authorized to read information from blockchain 430.

System 400 may also comprise agreement database 470 and, optionally, buffering database 480. In some embodiments, it may be computationally expensive to add transactions to a blockchain incrementally. Buffering database 480 may be one or more databases configured to buffer procurement requests for processing in a single block. Buffering database 480 may store individual requests from potential parties to a contract.

In some embodiments, system 400 may comprise a smart oracle 490. An oracle, in the context of blockchains and smart contracts, is a separate source of information, such as a data feed provided by a third-party service, or other external information, triggers, or conditions that may be submitted to the blockchain and used by smart contracts to trigger events on the blockchain. For example, a contract may be designed to execute when inventory reaches a certain level. The inventory level may be measured and/or provided by smart oracle 490. Oracle 490 may provide other alerts which may affect the execution of contracts.

Oracle 490 can be software or hardware. Oracle 490, for example, may be a hardware sensor that gets a measurement from the physical world, such as time or temperature, which may provide local and often real-time information. Oracle 490 can also be software that gets a data feed from data available online or elsewhere on network 440. Oracle 490 may also get, or create, aggregated data.

FIG. 5 depicts a schematic of exemplary computing system 500 for performing the envisioned systems and methods, consistent with disclosed embodiments. In some embodiments, computing system 500 includes a processor 510, memory 515, display 520, I/O interface(s) 525, and network adapter 530. These units may communicate with each other via bus 535, or wirelessly. The components shown in FIG. 5 may reside in a single device or multiple devices.

Consistent with disclosed embodiments, processor 510 may comprise a central processing unit (CPU), graphical processing unit (GPU), or similar microprocessor having one or more processing cores. Computing system 500 may include one or more processors 510 and may further operate with one or more other processors that are remote with respect to processors 510. Memory 515 may include non-transitory memory containing non-transitory instructions, such as a computer hard disk, random access memory (RAM), removable storage, or remote computer storage. In some aspects, memory 515 may be configured to store data and instructions, such as software programs. For example, memory 515 may be configured to store data and instructions. In some aspects, processor 510 may be configured to execute non-transitory instructions and/or programs stored on memory 515 to configure computing system 500 to perform operations of the disclosed systems and methods. In various aspects, as would be recognized by one of skill in the art, processor 510 may be configured to execute non-transitory instructions and/or programs stored on a remote memory to perform operations of the disclosed systems and methods.

Display 520 may be any device which provides a visual output, for example, a computer monitor or display, an LCD screen, etc. I/O interfaces 525 may include hardware and/or a combination of hardware and software for communicating information to computing system 500 from a user of computing system 500, such as a keyboard, mouse, trackball, audio input device, touch screen, infrared input interface, or similar device. Network adapter 530 may include hardware and/or a combination of hardware and software for enabling computing system 500 to exchange information using external networks, such as network 140. For example, network adapter 530 may include a wireless wide area network (WWAN) adapter, a Bluetooth module, a near field communication module, or a local area network (LAN) adapter.

Other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

What is claimed is:

1. A procurement system comprising:
at least one processor; and
at least one non-transitory memory containing instructions that, when executed by the at least one processor, cause the procurement system to perform operations comprising:
creating, in a blockchain, a contract corresponding to a procurement request including a first procurement parameter, the contract including contract code enforcing procurement obligations;
receiving, from at least one user system, at least one additional procurement request including at least one second procurement parameter and indicating the contract;
generating a contract execution result by executing the contract code using the first procurement parameter and the at least one second procurement parameter; and
updating the blockchain based on the contract execution result.

2. The procurement system of claim 1, wherein at least one of the first procurement parameter and the at least one second procurement parameter concern at least one of a unit quantity and a unit price.

3. The procurement system of claim 2, wherein the contract execution result indicates that the first procurement parameter and the at least one second procurement parameter jointly satisfy the procurement obligations.

4. The procurement system of claim 1, wherein the contract indicates a counterparty obligated to fulfil the procurement request.

5. The procurement system of claim 1, the operations further comprising receiving at least one counterparty obligation to fulfil the procurement request.

6. The procurement system of claim 1, wherein executing the contract code comprises receiving external resource data.

7. The procurement system of claim 6, wherein the external resource data concerns satisfaction of procurement obligations.

8. The procurement system of claim 6, wherein the procurement system executes the contract code in response to receipt of the external resource data.

9. The procurement system of claim 6, wherein the contract specifies at least one source of the external resource data.

10. The procurement system of claim 1, wherein the contract execution result comprises one or more software keys.

11. A management system comprising:
at least one processor; and
at least one non-transitory memory containing instructions that, when executed by the at least one processor, cause the management system to perform operations comprising:
storing procurement requests received from at least one user system in at least one database;
creating contracts in a blockchain that correspond to the procurement requests and comprise contract code enforcing procurement obligations;
providing input data concerning procurement obligations to the contracts;
receiving contract execution results generated by executing the contract code using the input data; and
outputting the contract execution results.

12. The management system of claim 11, the operations further comprising providing an indication of one or more of the contracts in the blockchain in response to a query received from the at least one user system.

13. The management system of claim 11, the operations further comprising storing rules implementing the procurement obligations in the at least one database, receiving information concerning procurement obligations, and applying the stored rules to the information to generate the input data.

14. The management system of claim 11, wherein the contract execution results comprises one or more software keys.

15. The management system of claim 11, wherein a contract execution result for one of the contracts indicates that multiple procurement requests jointly satisfy procurement obligations associated with the one of the contracts.

16. The management system of claim 11, wherein a procurement request corresponds to one of the contracts, the one of the contracts indicating a counterparty obligated to fulfil the procurement request.

17. The management system of claim 11, wherein a procurement request corresponds to one of the contracts, and the operations further comprising receiving a counterparty obligation to fulfil the procurement request.

18. A procurement method comprising:
creating contracts for group buying arrangements in a blockchain, the contracts including contract code enforcing procurement obligations;
receiving, from user systems, procurement requests to enter into the contracts;
prompting the contracts with input data concerning the procurement obligations;
receiving, in response to the prompting, contract execution results generated by executing the contract code using the input data; and
providing the contract execution results to the user systems.

19. The procurement method of claim 18, wherein the contract execution results comprise software keys.

20. The procurement method of claim 18, wherein creating contracts for group buying arrangements includes storing rules implementing the group buying arrangements in a database, receiving information concerning procurement obligations, and applying the stored rules to the information to generate the input data.
